(19) United States
(12) Patent Application Publication
(10) Pub. No.: US 2011/0120123 A1
(43) Pub. Date: May 26, 2011

(54) LOW PRESSURE TURBINE WASTE GATE FOR DIESEL ENGINE HAVING TWO STAGE TURBOCHARGER

(75) Inventors: Steven J. Dickerson, Lake in the Hills, IL (US); Paul Gottemoller, Palos Park, IL (US)

(73) Assignee: International Engine Intellectual Property Company , LLC, Warrenville, IL (US)

(21) Appl. No.: 12/623,974

(22) Filed: Nov. 23, 2009

(51) Int. Cl. F02D 23/00; F01N 3/00; F01N 3/023

(52) U.S. Cl. 60/602; 60/287; 60/295

(57) ABSTRACT

A diesel engine, having a two stage turbine for driving a two stage intake air compressor, includes a second stage bypass path arranged around the second stage turbine. The second stage bypass path includes a second stage control valve to open or close the second stage bypass path. Also, a first stage bypass path around the first stage turbine can be used along with the second stage bypass path. An engine control is configured to open or close the first and/or the second stage bypass paths during an operator command for vehicle acceleration. When the engine includes a DOC and a DPF, the engine control can open the second stage bypass path in order to increase passive regeneration of the DPF.

### TECHNICAL FIELD

This invention relates generally to motor vehicles, such as trucks, that are powered by internal combustion engines, particularly diesel engines that have turbochargers and exhaust gas treatment devices for treating exhaust gases passing through their exhaust systems.

### BACKGROUND

A known system for treating exhaust gas passing through an exhaust system of a diesel engine comprises a diesel oxidation catalyst (DOC) that oxidizes hydrocarbons (HC) to CO₂ and H2O and converts NO to NO₂, and a diesel particulate filter (DPF) that traps diesel particulate matter (DPM). DPM includes soot or carbon, the soluble organic fraction (SOF), and ash (i.e. lube oil additives etc.). The DPF is located downstream of the DOC in the exhaust gas flow. The combination of these two exhaust gas treatment devices prevents significant amounts of pollutants such as hydrocarbons, carbon monoxide, soot, SOF, and ash, from entering the atmosphere. The trapping of DPM by the DPF prevents black smoke from being emitted from a vehicle's exhaust pipe.

The DOC oxidizes hydrocarbons (HC) and converts NO to NO₂. The organic constituents of trapped DPM within the DPF, i.e., carbon and SOF, are oxidized within the DPF, using the NO₂ generated by the DOC, to form CO₂ and H₂O, which can then exit the exhaust pipe to atmosphere.

The rate at which trapped carbon is oxidized to CO₂ is controlled not only by the concentration of NO₂ or O₂ but also by temperature. Specifically, there are three important temperature parameters for a DPF.

The first temperature parameter is the oxidation catalyst's “light off” temperature, below which catalyst activity is too low to oxidize HC. Light off temperature is typically around 250° C.

The second temperature parameter controls the conversion of NO to NO₂. This NO conversion temperature spans a range of temperatures having both a lower bound and an upper bound, which are defined as the minimum temperature and the maximum temperature at which 40% or greater NO conversion is achieved. The conversion temperature window defined by those two bounds extends from approximately 250° C. to approximately 450° C.

The third temperature parameter is related to the rate at which carbon is oxidized in the filter. Reference sources in relevant literature call that temperature the “Balance Point Temperature” (or BPT). It is the temperature at which the rate of oxidation of particulate, also sometimes referred to as the rate of DPF regeneration, is equal to the rate of accumulation of particulate. The BPT is one of the parameters that determines the ability of a DPF to enable a diesel engine to meet expected tailpipe emissions laws and/or regulations.

Typically, a diesel engine runs relatively lean and relatively cool compared to a gasoline engine. That factor makes natural achievement of BPT problematic.

Therefore, a DPF requires regeneration from time to time in order to maintain particulate trapping efficiency. Regeneration involves the presence of conditions that will burn off trapped particulates whose unchecked accumulation would otherwise impair DPF effectiveness. While “regeneration” refers to the general process of burning off DPM, two particular types of regeneration are recognized by those familiar with the regeneration technology as presently being applied to motor vehicle engines.

“Passive regeneration” is generally understood to mean regeneration that can occur anytime that the engine is operating under conditions that burn off DPM without initiating a specific regeneration strategy embodied by algorithms in an engine control system. “Active regeneration” is generally understood to mean regeneration that is initiated intentionally, either by the engine control system on its own initiative or by the driver causing the engine control system to initiate a programmed regeneration strategy, with the goal of elevating temperature of exhaust gases entering the DPF to a range suitable for initiating and maintaining burning of trapped particulates.

Active regeneration may be initiated even before a DPF becomes loaded with DPM to an extent where regeneration would be mandated by the engine control system on its own. When DPM loading beyond that extent is indicated to the engine control system, the control system forces active regeneration, and that is sometimes referred to simply as a forced regeneration.

The creation of conditions for initiating and continuing active regeneration, whether forced or not, generally involves elevating the temperature of exhaust gas entering the DPF to a suitably high temperature.

There are several methods for initiating a forced regeneration of a DPF such as retarding the start of main fuel injections or post-injection of diesel fuel to elevate exhaust gas temperatures entering the DPF while still leaving excess oxygen for burning the trapped particulate matter. Post-injection may be used in conjunction with other procedures and/or devices for elevating exhaust gas temperature to the relatively high temperatures needed for active DPF regeneration.

These methods are able to increase the exhaust gas temperature sufficiently to elevate the catalyst's temperature above catalyst “light off” temperature and provide excess HC that can be oxidized by the catalyst. Such HC oxidation provides the necessary heat to raise the temperature in the DPF above the BPT.

A known turbocharger system for an engine comprises a two-stage turbocharger that comprises high- and low-pressure turbines in series flow relationship and a bypass valve that is in parallel flow relationship to the high-pressure turbine and under the control of the engine control system. The engine control system processes various data to control the bypass valve such that exhaust back-pressure and engine boost are regulated in an appropriate way according to the manner in which the engine is being operated. The high-pressure stage can be designed to have a relatively smaller size that is optimized for low-end engine performance while the low-pressure stage can be designed with a relatively larger size for high-end performance.

The present inventors have recognized that during part load engine operation, passive regeneration of the DPF is difficult because the exhaust temperatures are low.

Additionally, the present inventors have recognized that during vehicle launch a second stage turbine reduces the effectiveness of the first age turbine by adding exhaust restriction thereby lowering the first stage turbine expansion ratio.

### SUMMARY

An exemplary embodiment of the invention includes a diesel engine having a two stage turbine for driving an intake air compressor, the two stage turbine having a first stage turbine that receives exhaust gas from the diesel engine into a first stage inlet and discharges exhaust gas through a first stage outlet, and a second stage turbine having a second stage inlet receiving the exhaust gas from the first stage outlet, and passing the exhaust gas out of a second stage outlet. According to the exemplary embodiment, a second stage bypass path is arranged around the second stage turbine. The second stage bypass passes exhaust gas from the second stage inlet to the second stage outlet, the bypass path including a second stage control valve to open or close the second stage bypass path.

Also, a first stage bypass path around the first stage turbine can be used along with the second stage bypass path. The first stage bypass path passes exhaust gas from the first stage inlet to the first stage outlet, the bypass path including a first stage control valve to open or close the first stage bypass path.

An engine control is configured to open or close the first and/or the second stage bypass paths during an operator command for vehicle acceleration.

Furthermore, when the engine includes a DOC and a DPF, the engine control can open the second stage bypass path in order to increase passive regeneration of the DPF.

A sensor that indicates a need to the engine control for an increase in passive regeneration can trigger opening or closing of the first and/or the second stage bypass paths.

The engine control can also at least partially open the first stage bypass path in order to increase passive regeneration of the DPF.

An exemplary method of the invention of increasing passive regeneration of a DPF in a diesel engine having a DOC upstream of the DPF, the engine having an intake manifold and an exhaust manifold, the intake manifold being charged with intake air by a two stage turbocharger comprising first and second stage compressors driven by first and second stage turbines, comprises the steps of:

during normal, steady state operation, expelling exhaust gas at a high temperature from the exhaust manifold into the first stage turbine and from the first stage turbine into the second stage turbine to rotationally drive the first and second stage compressors to charge intake air into the intake manifold; and

when an engine control determines that an increase in passive regeneration is needed, bypassing the exhaust gas around the second stage turbine to increase exhaust gas temperature into the DOC.

The method can include the step of sensing the degree of particulate accumulation in the DPF and if particulate accumulation in the DPF is greater than a predetermined limit, then bypassing the exhaust gas around the second stage turbine to increase exhaust gas temperature into the DOC.

Alternately, the method can include the step of bypassing the second stage turbine according to a predetermined regularity.

The method can include the further step of at least partially bypassing the exhaust gas around the first stage turbine when the engine control determines that an increase in passive regeneration is needed.

An exemplary method of increasing power a diesel engine is also provided that includes the steps of:

during normal, steady state operation, expelling exhaust gas at a high temperature from the exhaust manifold into the first stage turbine and from the first stage turbine into the second stage turbine to rotationally drive the first and second stage compressors to charge intake air into the intake manifold; and

when an increase in power is needed, bypassing the exhaust gas around the second stage turbine to increase spool up of the first stage turbine.

Accordingly, when the second stage bypass path or waste gate is opened alone or in conjunction with the first stage bypass path or waste gate, the exhaust temperature is increased and passive regeneration is increased. Also, during vehicle launch, opening the second stage waste gate will reduce the exhaust restriction, causing an increase in the first stage turbine expansion ratio. This will in turn increase the speed at which the first stage turbine spools up, which will increase the rate of rise of the compressor boost pressure. Engine power as a function of time will be increased and vehicle acceleration will be improved.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematic illustration of a representative diesel engine and control with two stage turbocharger and exhaust after-treatment devices;

FIG. 2 is a fragmentary schematic side view of a two stage turbine arrangement;

FIG. 3 is a fragmentary sectional view taken generally along line 3-3 of FIG. 2; and

FIG. 4 is a control algorithm according to one aspect of the present invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

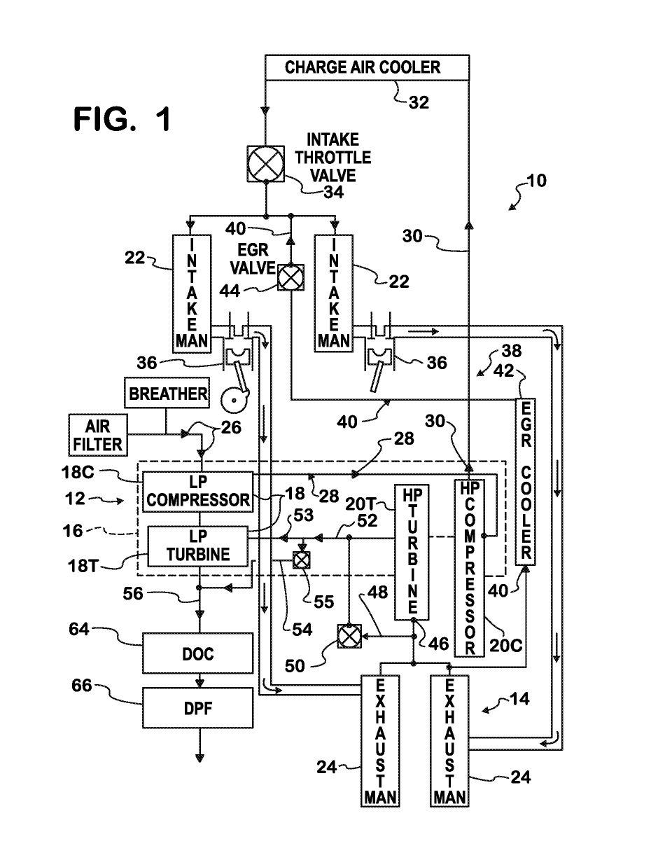

FIG. 1 shows an exemplary internal combustion engine 10 having an intake system 12 through which air for combustion enters the engine and an exhaust system 14 through which exhaust gas resulting from combustion exits the engine. Engine 10 is, by way of example, a turbocharged diesel engine comprising a two-stage turbocharger 16 that has a low-pressure stage 18 and a high-pressure stage 20. By way of example, engine 10 is a multi-cylinder V-type engine having intake manifolds 22 and exhaust manifolds 24, and when used in a motor vehicle, such as a truck, is coupled through a drivetrain (not shown) to propel the vehicle.

Air drawn into intake system 12 follows an entrance path indicated by arrows 26 leading to a compressor 18C of low-pressure stage 18. A compressor 20C of high-pressure stage 20 is in downstream series flow relationship to compressor 18C via a path marked by arrows 28. A path marked by arrows 30 continues from compressor 20C through a charge air cooler 32 and an intake throttle valve 34 to intake manifolds 22.

From intake manifolds 22, charge air enters engine cylinders 36 into which fuel is injected to form a mixture that is combusted to power the engine. Gas resulting from combustion is exhausted through exhaust system 14, but some portion may be recirculated through an exhaust gas recirculation (EGR) system 38. Recirculated exhaust gas from exhaust manifolds 24 follows a path marked by arrows 40 through an EGR cooler 42 and an EGR valve 44 back to intake manifolds 22.

Upon leaving exhaust manifolds 24, exhaust gas that is not recirculated is constrained to take one or both of two parallel paths marked by respective arrows 46, 48. Path 46 comprises a turbine 20T of high-pressure stage 20, and path 48 comprises a bypass valve 50. After turbine 20T and valve 50, the paths 46, 48 merge into a common path 52 that leads to one or both of two parallel paths marked by respective arrows 53, 54. Path 53 comprises a turbine 18T of low-pressure stage 18, and path 54 comprises a bypass valve 55. After turbine 18T and valve 55, the paths 53, 54 merge into a common exhaust path 56. Exhaust gas in path 56 may pass through one or more exhaust gas treatment devices, such as a DOC 64, and a DPF 66 before being exhausted to atmosphere.

Exhaust bypass valves 50, 55 are under the control of the engine control system. The engine control system processes various data to control the valves 50, 55 such that exhaust back-pressure and engine boost are regulated in an appropriate manner according to the manner in which the engine is being operated. An advantage of having two turbines 20T, 18T in series flow relationship, with valve 50 providing for control of the amount of exhaust gas allowed to bypass turbine 20T, and with valve 55 providing for control of the amount of exhaust gas allowed to bypass turbine 18T is that high-pressure stage 20 can be designed to be smaller in size and optimized for low-end engine performance, while low-pressure stage 18 can be designed to be larger in size for better high-end performance.

By opening exhaust bypass valve 55 and closing exhaust bypass valve 50 during low-end engine operation, the entire exhaust gas flow passes through turbine 20T, and bypasses turbine 18T and high-pressure compressor 20C will develop higher outlet pressure that so that the charge air is developed by both compressor stages. This can provide desirable increased low-end boost.

Over a mid-speed range and high end of engine operation, valves 50, 55 may be operated to partially open or fully open condition as appropriate to achieve desired boost and back-pressure.

The inventive turbocharger bypass control (TCBC) strategy is embodied in the engine control system which comprises one or more processors containing algorithms for processing data. Through control of valves 50, 55 the strategy may be considered to control the set-point for turbocharger operation.

Additionally, by bypassing the turbine 18T, exhaust gas entering the DOC will be maintained at a sufficiently elevated temperature to assure a passive regeneration of the DPF without the need to inject diesel fuel into the exhaust upstream of the DOC. A fuel savings can be realized. During vehicle launch, opening the valve 55 will reduce the exhaust restriction downstream of the turbine 20T, causing an increase in the expansion ratio of the turbine 20T. This will in turn increase the speed at which the turbine 20T spools up, which will increase the rate of rise of the compressor boost pressure. Engine power as a function of time will be increased and vehicle acceleration will be improved.

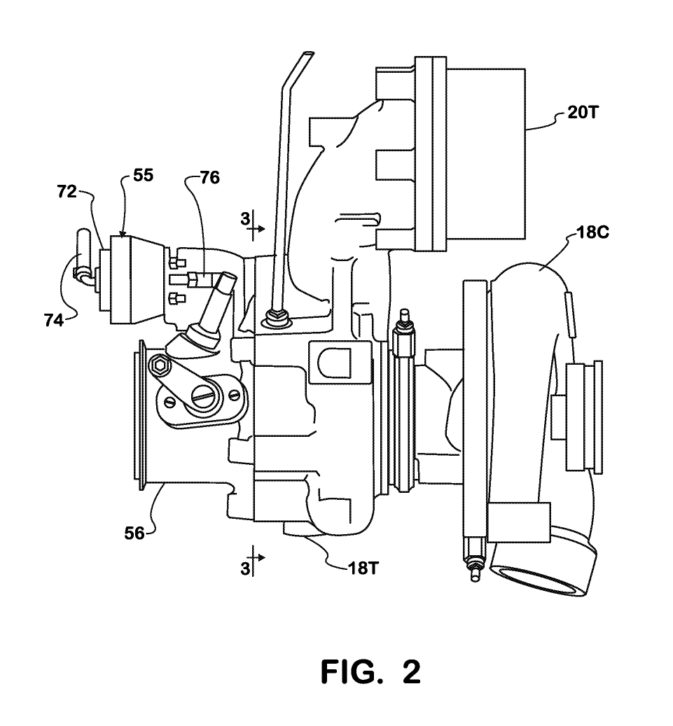

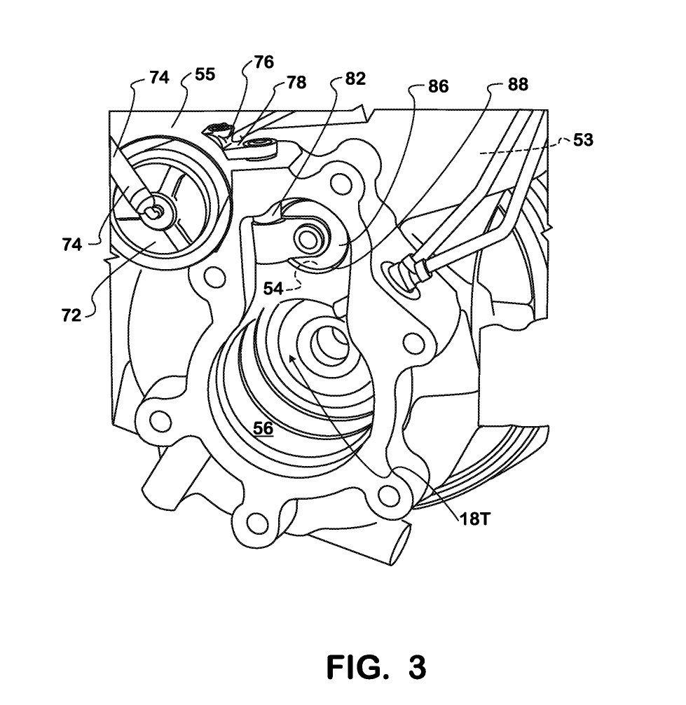

FIGS. 2 and 3 illustrate one manner of embodiment of the bypass valve 55. The valve 55 includes an actuator 72 such as an air pressure or vacuum operator connected to a source of controllable air pressure. Alternately the actuator 72 could be an electric solenoid or other type actuator. The actuator is controlled by the engine control module. The valve 50 is controlled in a similar fashion by the engine control module.

The actuator 72 moves a rod 76 axially which is pin connected to a lever 78 which is fixedly connected to a spindle 82 which is fixedly connected to a valve element 86 which closes onto a valve seat 88 when the valve 55 is in a closed position. When a command for opening from the engine control module is sent to the actuator 72, the rod 76 is extended which pivots the lever 78 and the spindle 82 which swings the valve element 86 away from the seat 88. Exhaust gas will then bypass the turbine wheel of the turbine 18T from the passage 53 to the passage or path 56 through the passage or path 54 that is otherwise closed by the valve element 86.

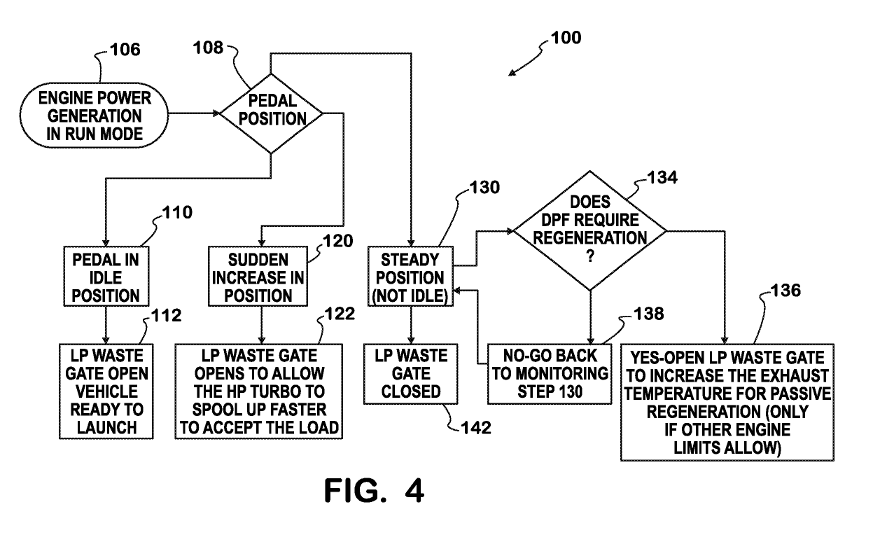

FIG. 4 illustrates a control scheme 100 for operating the valve 55 to increase acceleration performance of the truck driven by the engine and also to maximize passive regeneration of the DPF. In a first step 106, the engine control is in a run mode. The pedal position is monitored in step 108. If the pedal is sensed to be in an idle position, step 110, the engine control module maintains the valve 55 in an open position, in step 112. If the pedal is sensed to be moved to increase speed in a sudden manner, step 120, the engine control module maintains the valve 55 in an open position in order to allow the turbine 20T to spool up, or speed up, rapidly to accept the load, step 122. If the pedal is sensed to be in a steady position, but not at idle, step 130, the engine control module determines whether an increase in passive DPF regeneration is required, step 134. If an increase in passive DPF regeneration is required based on for example pressure drop across the DPF, the valve 55 is opened to increase the exhaust gas temperature for passive regeneration, step 136, but only if other engine operational constraints permit. If an increase in passive regeneration is not required, step 138 returns the control to the pedal monitoring function, step 130 and then to step 142 which closes the valve 55 for normal, steady state power from the low pressure stage turbine 18T.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. In a diesel engine having a two stage turbine for driving an intake air compressor, the two stage turbine having a first stage turbine that receives exhaust gas from the diesel engine into a first stage inlet and discharges exhaust gas through a first stage outlet, and a second stage turbine having a second stage inlet receiving the exhaust gas from the first stage outlet, and passing the exhaust gas out of a second stage outlet, the improvement comprising:
a second stage bypass path around the second stage turbine that passes exhaust gas from the second stage inlet to the second stage outlet, the bypass path including a second stage control valve to open or close the second stage bypass path.

2. The improvement according to claim 1, further comprising a first stage bypass path around the first stage turbine that passes exhaust gas from the first stage inlet to the first stage outlet, the first stage bypass path including a first stage control valve to open or close the first stage bypass path.

3. The improvement according to claim 2, comprising an engine control that opens the second stage control valve during an operator command for vehicle acceleration.

4. The improvement according to claim 2, wherein the engine includes a DOC and a DPF, and comprising an engine control that opens the second stage control valve in order to increase passive regeneration of the DPF.

5. The improvement according to claim 4, comprising a sensor that indicates a need to the engine control for an increase in passive regeneration.

6. The improvement according to claim 5, wherein the engine control also at least partially opens the first stage control valve in order to increase passive regeneration of the DPF.

7. The improvement according to claim 1, comprising an engine control that opens the second stage control valve during an operator command for vehicle acceleration.

8. The improvement according to claim 1, wherein the engine includes a DOC and a DPF, and comprising an engine control that opens the second stage control valve in order to increase passive regeneration of the DPF.

9. The improvement according to claim 8, comprising a sensor that indicates a need to the engine control for an increase in passive regeneration.

10. The improvement according to claim 8, wherein the engine control also at least partially opens the first stage control valve in order to increase passive regeneration of the DPF.

11. A method of increasing passive regeneration of a DPF in a diesel engine having a DOC upstream of the DPF, the engine having an intake manifold and an exhaust manifold, the intake manifold being charged with intake air by a two stage turbocharger comprising first and second stage compressors driven by first and second stage turbines, comprising the steps of:
during normal, steady state operation, expelling exhaust gas at a high temperature from the exhaust manifold into the first stage turbine and from the first stage turbine into the second stage turbine to rotationally drive the first and second stage compressors to charge intake air into the intake manifold; and
when an engine control determines that an increase in passive regeneration is needed, bypassing the exhaust gas around the second stage turbine to increase exhaust gas temperature into the DOC.

12. The method according to claim 11, wherein the step of bypassing is further defined in that the degree of particulate accumulation in the DPF is sensed and if particulate accumulation in the DPF is greater than a predetermined limit, then bypassing the exhaust gas around the second stage turbine to increase exhaust gas temperature into the DOC.

13. The method according to claim 11, wherein the step of bypassing is further defined in that the bypassing is done according to a predetermined regularity.

14. The method according to claim 11, comprising the further step of:
when the engine control determines that an increase in passive regeneration is needed, at least partially bypassing the exhaust gas around the first stage turbine.

15. A method of increasing power a diesel engine, the engine having an intake manifold and an exhaust manifold, the intake manifold being charged with intake air by a two stage turbocharger comprising first and second stage compressors driven by first and second stage turbines, comprising the steps of:
during normal, steady state operation, expelling exhaust gas at a high temperature from the exhaust manifold into the first stage turbine and from the first stage turbine into the second stage turbine to rotationally drive the first and second stage compressors to charge intake air into the intake manifold; and
when an increase in power is needed, bypassing the exhaust gas around the second stage turbine to increase spool up of the first stage turbine.
